(19) United States
(12) Patent Application Publication
(10) Pub. No.: US 2008/0165073 A1
(43) Pub. Date: Jul. 10, 2008

(54) OMNI-DIRECTIONAL HIGH GAIN DIPOLE ANTENNA

(75) Inventor: Keng-Hung Chou, Taipei County (TW)

Correspondence Address: STEVENS & SHOWALTER LLP, 7019 CORPORATE WAY, DAYTON, OH, 45459-4238, US

(73) Assignee: SMARTANT TELECOM CO., LTD., Hsinchu County (TW)

(21) Appl. No.: 11/971,742

(22) Filed: Jan. 9, 2008

(30) Foreign Application Priority Data
Jan. 10, 2007 (TW) 096200512

(51) Int. Cl. H01Q 1/36; H01Q 9/16

(52) U.S. Cl. 343/793; 343/895

(57) ABSTRACT

An omni-directional high gain dipole antenna includes a first rod antenna portion, a first helical antenna portion, a second rod antenna portion, a second helical antenna portion, and an impedance matching portion. The helical antenna portions having different helical pitches are serially-connected to the rod antenna portions, so as to prolong an antenna array distance of the dipole antenna. The serially-connected impedance matching portion adjusts a line impedance value of the dipole antenna, so as to enhance a radiation field pattern gain of the dipole antenna.

### CROSS-REFERENCE TO RELATED APPLICATIONS

This non-provisional application claims priority under 35 U.S.C. §119(a) on Patent Application No(s). 096200512 filed in Taiwan, R.O.C. on Jan. 10, 2007, the entire contents of which are hereby incorporated by reference.

### BACKGROUND OF THE INVENTION

1. Field of Invention

The present invention relates to a dipole antenna, and more particularly to an omni-directional high gain dipole antenna.

2. Related Art

With the development of wireless communication technology, various products and techniques applied for frequency multiplexing come into being. Thus, many electronic products have the function of wireless communication to meet the requirement of the consumers. Antenna is an important element in a wireless communication system for emitting and receiving electromagnetic wave energy, and dipole antennae or helical antennae are generally utilized.

As for antennae used in various electronic products at present, the design and material of the antennae differ from each other. Besides, the design of the antenna varies according to the adopted frequency band. Currently, the frequency band specification for wireless local area network (WLAN) is generally IEEE 802.11. 802.11 may be further divided into 802.11a, 802.11b, and 802.11g, in which 802.11a specifies 5 GHz frequency band, while 802.11b and 802.11g specify 2.4 GHz. The antennae applied to WLAN are usually designed into omni-directional radiation. On the design of antennae with omni-directional radiation, monopole or dipole antennae are generally adopted. However, as the gain of a monopole or dipole antenna is low, the insufficiency on gain is usually compensated by using an array or adding an external gain circuit. The manner of adding the external gain circuit may increase the manufacturing cost of the antenna, and thus increase the manufacturing cost of the products for manufacturers of wireless communication system.

### SUMMARY OF THE INVENTION

In view of the above problem, the present invention is mainly directed to an omni-directional high gain dipole antenna. Helical antenna portions having different helical pitches are connected to rod antenna portions, so as to prolong an antenna array distance of the dipole antenna. Besides, an impedance matching portion is serially-connected to adjust a line impedance value of the dipole antenna, so as to enhance a radiation field pattern gain of the dipole antenna.

An omni-directional high gain dipole antenna provided by the present invention includes a first rod antenna portion, a first helical antenna portion, a second rod antenna portion, a second helical antenna portion, and an impedance matching portion.

The first helical antenna portion is serially-connected to the first rod antenna portion, and has a first helical pitch. The second rod antenna portion is serially-connected to the first helical antenna portion. The second helical antenna portion is serially-connected to the second rod antenna portion, and has a second helical pitch. The impedance matching portion is serially-connected to the second helical antenna portion, for matching a line impedance of the dipole antenna. The first rod antenna portion, the first helical antenna portion, the second rod antenna portion, and the second helical antenna portion are connected to each other by, for example, welding or are integrally formed. The first helical pitch may be greater or smaller than the second helical pitch, as long as the first helical pitch is not equal to the second helical pitch.

As for the omni-directional high gain dipole antenna, different helical pitches are designed for the helical antenna portions according to different operating frequencies, so as to obtain a preferred radiation field pattern gain. Therefore, no external gain circuit is needed for compensating the insufficiency on gain, thus reducing the design cost of the wireless communication system. Moreover, as the dipole antenna is integrally formed, its fabrication process is accelerated and becomes more convenient.

### BRIEF DESCRIPTION OF THE DRAWINGS

The present invention will become more fully understood from the detailed description given herein below for illustration only, and thus are not limitative of the present invention, and wherein:

FIG. 1A is a schematic view of the appearance of a first embodiment of the present invention;

FIG. 1B is a schematic view of the appearance of a second embodiment of the present invention;

FIGS. 2A, 2B, and 2C are schematic views showing H-polarized radiation field patterns of the first embodiment of the present invention; and

FIGS. 3A, 3B, and 3C are schematic views showing V-polarized radiation field patterns of the first embodiment of the present invention.

### DETAILED DESCRIPTION OF THE INVENTION

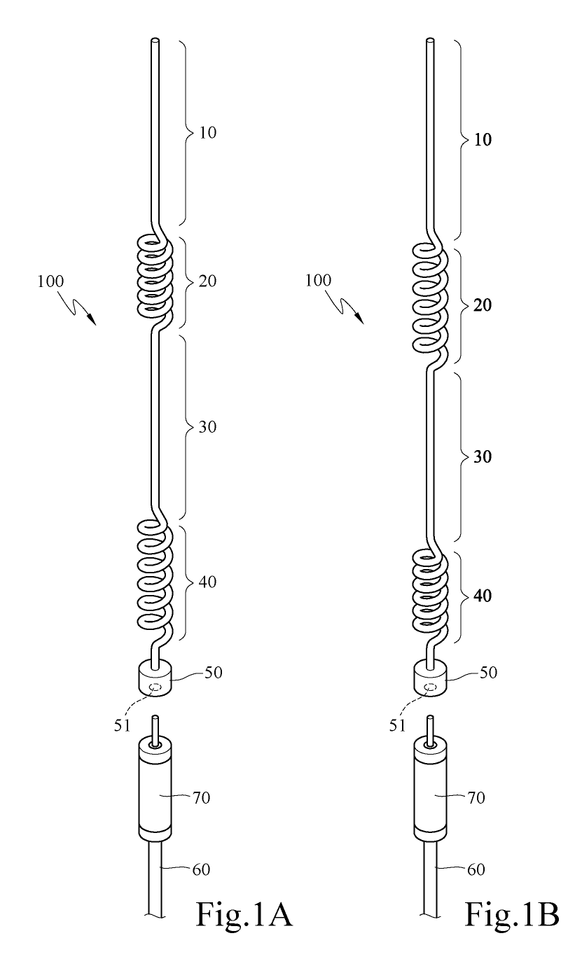

Referring to FIG. 1A, a schematic view of the appearance of a first embodiment of the present invention is shown. In FIG. 1A, a omni-directional high gain dipole antenna 100 of the present invention includes a first rod antenna portion 10, a first helical antenna portion 20, a second rod antenna portion 30, a second helical antenna portion 40, and an impedance matching portion 50.

The first rod antenna portion 10 is approximately in the shape of a straight line with an approximately circular cross-section. The first rod antenna portion 10 further has a length of ½ wavelength (λ) of a carrier frequency, and is made of a metal conductive material (for example, copper or iron). In addition, the first rod antenna portion 10 is, for example, of a solid structure or a hollow structure.

The first helical antenna portion 20 is, for example, connected to an end of the first rod antenna portion 10 by welding or the two portions are integrally formed. The first helical antenna portion 20 has a length of ½ wavelength (λ) of a carrier frequency, and is made of a metal conductive material (for example, copper or iron). The first helical antenna portion 20 is approximately in the shape of a spring with an approximately circular cross-section, and has a first helical pitch. The first helical pitch may be adjusted to alter the radiation field pattern gain value and the line impedance value of the dipole antenna 100. Besides, the spring-shaped structure may prevent noise interferences caused by the pass-through of a current signal, thereby improving the signal transmission quality. In addition, the first helical antenna portion 20 is, for example, of a solid structure or a hollow structure.

The second rod antenna portion 30 is, for example, connected to the first helical antenna portion 20 by welding, or the two portions are integrally formed. The second rod antenna portion 30 is approximately in the shape of a straight line with an approximately circular cross-section. Further, the second rod antenna portion 30 has a length of ½ wavelength (λ) of a carrier frequency, and is made of a metal conductive material (for example, copper or iron). In addition, the second rod antenna portion 30 is, for example, of a solid structure or a hollow structure.

The second helical antenna portion 40 is, for example, connected to the second rod antenna portion 30 by welding, or the two portions are integrally formed. The second helical antenna portion 40 has a length of ½ wavelength (λ) of a carrier frequency, and is made of a metal conductive material (for example, copper or iron). The second helical antenna portion 40 is approximately in the shape of a spring with an approximately circular cross-section, and has a second helical pitch. The second helical pitch may be adjusted to alter the radiation field pattern gain value and the line impedance value of the dipole antenna 100. Besides, the spring-shaped structure may prevent the noise interferences caused by the pass-through of the current signal, thereby improving the signal transmission quality. In addition, the second helical antenna portion 40 is, for example, of a solid structure or a hollow structure.

Further, in the first embodiment of the present invention, the first helical pitch of the first helical antenna portion 20 is smaller than the second helical pitch of the second helical antenna portion 40.

The impedance matching portion 50 is connected to the second helical antenna portion 40 by welding, and is approximately in the shape of a cylinder with an approximately circular cross-section, for matching the line impedance of the dipole antenna. The impedance matching portion 50 has a signal feed-in point 51 at its center, in which the signal feed-in point 51 is connected to a signal cable 60 for transmitting a wireless signal. In addition, the impedance matching portion 50 is of a solid structure, and is made of a metal conductive material (for example, copper or iron). The impedance matching portion 50 has a length of ¼ wavelength (λ) of a carrier frequency.

A metal tube 70 is made of a metal conductive material (for example, copper or iron) and is approximately in the shape of a round tube. The metal tube 70 has a length of ¼ wavelength (λ) of a carrier frequency, and is electrically coupled to a ground net of the signal cable 60. Further, the signal cable 60 is fixed in the metal tube 70 through an insulating pad (not shown), so as to prevent the signal cable 60 from contacting the metal tube 70, thus avoiding affecting the current on the metal tube 70. In addition, the metal tube 70 contributes to the impedance matching. The radiation current direction of the metal tube 70 is forward, the same as the current directions of the above first rod antenna portion 10 and second rod antenna portion 30, thus constituting a dipole antenna of ½ wavelength (λ).

Referring to FIG. 1B, a schematic view of the appearance of a second embodiment of the present invention is shown. In FIG. 1B, the omni-directional high gain dipole antenna 100 of the present invention includes the first rod antenna portion 10, the first helical antenna portion 20, the second rod antenna portion 30, the second helical antenna portion 40, and the impedance matching portion 50.

The first rod antenna portion 10 is in the shape of a straight line with an approximately circular cross-section. The first rod antenna portion 10 further has a length of ½ wavelength (λ) of a carrier frequency, and is made of a metal conductive material (for example, copper or iron). In addition, the first rod antenna portion 10 is, for example, of a solid structure or a hollow structure.

The first helical antenna portion 20 is, for example, connected to an end of the first rod antenna portion 10 by welding, or the two portions are integrally formed. The first helical antenna portion 20 has a length of ½ wavelength (λ) of a carrier frequency, and is made of a metal conductive material (for example, copper or iron). The first helical antenna portion 20 is approximately in the shape of a spring with an approximately circular cross-section, and has a first helical pitch. The first helical pitch may be adjusted to alter the radiation field pattern gain value and the line impedance value of the dipole antenna 100. Besides, the spring-shaped structure may prevent noise interferences caused by the pass-through of a current signal, thereby improving the signal transmission quality. In addition, the first helical antenna portion 20 is, for example, of a solid structure or a hollow structure.

The second rod antenna portion 30 is, for example, connected to the first helical antenna portion 20 by welding, or the two portions are integrally formed. The second rod antenna portion 30 is approximately in the shape of a straight line with an approximately circular cross-section. Further, the second rod antenna portion 30 has a length of ½ wavelength (λ) of a carrier frequency, and is made of a metal conductive material (for example, copper or iron). In addition, the second rod antenna portion 30 is, for example, of a solid structure or a hollow structure.

The second helical antenna portion 40 is, for example, connected to the second rod antenna portion 30 by welding, or the two portions are integrally formed. The second helical antenna portion 40 has a length of ½ wavelength (λ) of a carrier frequency, and is made of a metal conductive material (for example, copper or iron). The second helical antenna portion 40 is approximately in the shape of a spring with an approximately circular cross-section, and has a second helical pitch. The second helical pitch may be adjusted to alter the radiation field pattern gain value and the line impedance value of the dipole antenna 100. Besides, the spring-shaped structure may prevent noise interferences caused by the pass-through of the current signal, thereby improving the signal transmission quality. In addition, the second helical antenna portion 40 is, for example, of a solid structure or a hollow structure.

Further, in the second embodiment of the present invention, the first helical pitch of the first helical antenna portion 20 is greater than the second helical pitch of the second helical antenna portion 40.

The impedance matching portion 50 is connected to the second helical antenna portion 40 by welding, and is approximately in the shape of a cylinder with an approximately circular cross-section, for matching a line impedance of the dipole antenna. The impedance matching portion 50 has the signal feed-in point 51 at its center, in which the signal feed-in point 51 is connected to the signal cable 60 for transmitting a wireless signal. In addition, the impedance matching portion 50 is of a solid structure, and is made of a metal conductive material (for example, copper or iron). The impedance matching portion 50 has a length of ¼ wavelength (λ) of a carrier frequency.

The metal tube 70 is made of a metal conductive material (for example, copper or iron) and is approximately in the shape of a round tube. The metal tube 70 has a length of ¼ wavelength (λ) of a carrier frequency, and is electrically coupled to a ground net of the signal cable 60. Further, the signal cable 60 is fixed in the metal tube 70 through an insulating pad (not shown), so as to prevent the signal cable 60 from contacting the metal tube 70, thus avoiding affecting the current on the metal tube 70. In addition, the metal tube 70 contributes to the impedance matching. The radiation current direction of the metal tube 70 is forward, the same as the current directions of the above first rod antenna portion 10 and second rod antenna portion 30, thus constituting a dipole antenna of ½ wavelength (λ).

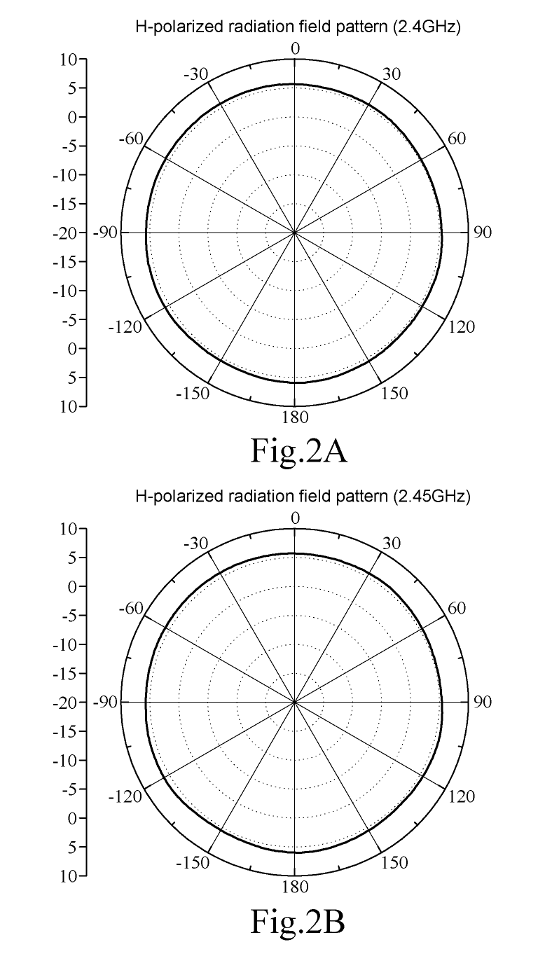

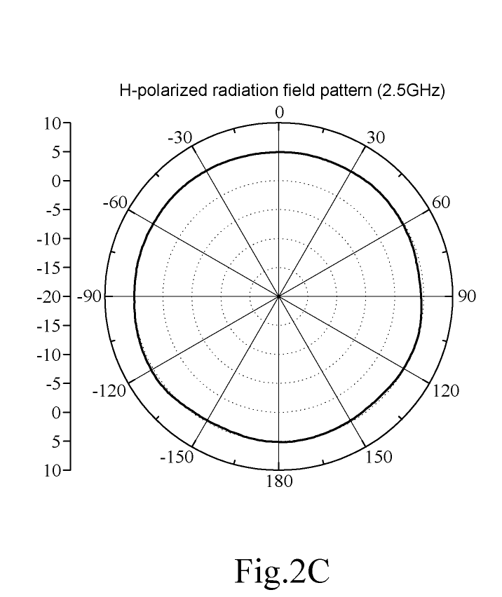

Next, referring to FIGS. 2A, 2B, and 2C, H-polarized radiation field patterns of the first embodiment of the present invention are shown, in which the operating frequency is respectively 2.4 GHz, 2.45 GHz, and 2.5 GHz for different tests.

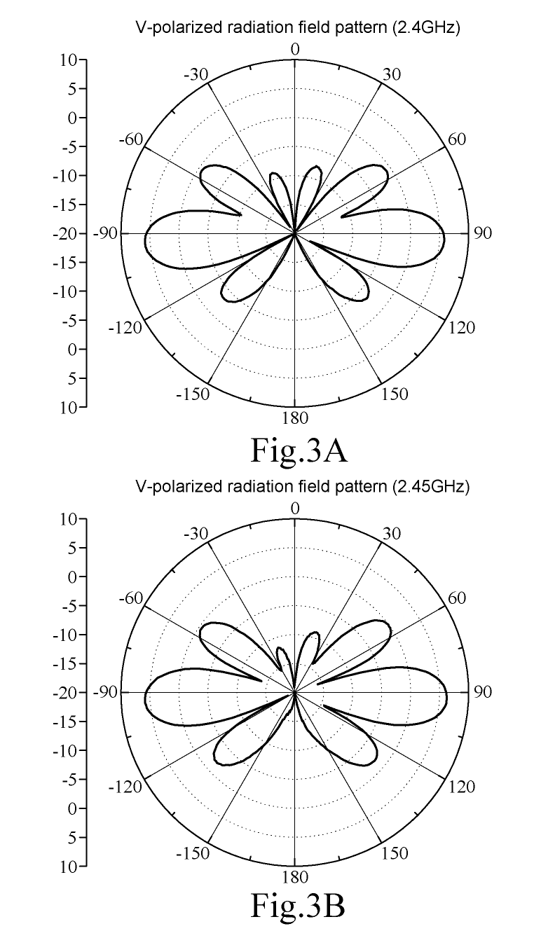

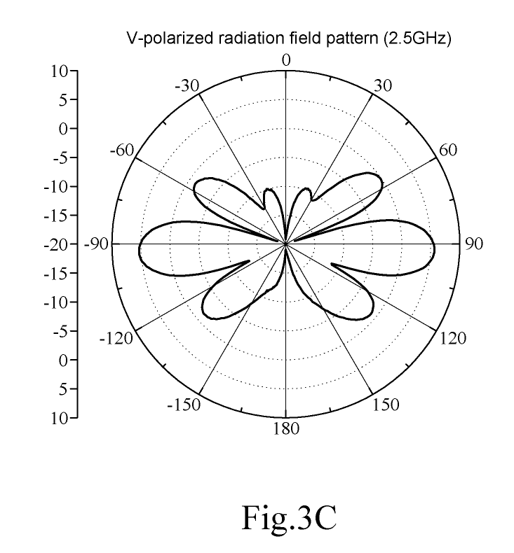

Then, referring to FIGS. 3A, 3B, and 3C, V-polarized radiation field patterns of the first embodiment of the present invention are shown, in which the operating frequency is respectively 2.4 GHz, 2.45 GHz, and 2.5 GHz for different tests.

Thereafter, referring to Table 1, a copper dipole antenna having helical antenna portions of different helical pitches (referred to as a first type of antenna below) is compared with a copper dipole antenna having helical antenna portions of identical helical pitches (referred to as a second type of antenna below) in terms of operating frequency, voltage standing wave ratio (VSWR), and radiation field pattern gain value.

TABLE 1

| | Antenna Type | | | | | |
|---|---|---|---|---|---|---|
| | Having Different | | | Having Identical | | |
| Item | Helical Pitches | | | Helical Pitches | | |
| Operating Frequency (GHz) | 2.4 | 2.45 | 2.5 | 2.4 | 2.45 | 2.5 |
| VSWR | 1.54 | 1.18 | 1.62 | 1.77 | 1.44 | 1.36 |
| H-polarized Maximum Gain | 5.76 | 5.90 | 5.49 | 5.35 | 5.68 | 5.35 |
| Value (dBi) | | | | | | |
| V-polarized Maximum Gain | 5.34 | 5.54 | 5.13 | 4.93 | 5.21 | 5.04 |
| Value (dBi) | | | | | | |
| H-polarized Mean Gain | 5.52 | 5.50 | 4.86 | 4.98 | 5.21 | 4.66 |
| Value (dBi) | | | | | | |
| V-polarized Mean Gain | −2.52 | −2.25 | −2.70 | −2.95 | −2.56 | −2.82 |
| Value (dBi) | | | | | | |

Seen from Table 1, the VSWR of the first type of antenna is smaller than that of the second type of antenna at the operating frequencies of 2.4 GHz and 2.45 GHz. Moreover, as the first type of antenna has a longer antenna array distance, the radiation field pattern gain value of the first type of antenna is 0.3 dBi higher than that of the second type of antenna at the operating frequencies of 2.4 GHz, 2.45 GHz, and 2.5 GHz.

In view of the above, as for the omni-directional high gain dipole antenna of the present invention, different helical pitches are designed for the helical antenna portions at different operating frequencies, so as to obtain a preferred radiation field pattern gain. Therefore, no external gain circuit is needed for compensating the insufficiency on gain, thus reducing the design cost of the wireless communication system. Moreover, as the dipole antenna is integrally formed, its fabrication process is accelerated and becomes more convenient.

What is claimed is:

1. An omni-directional high gain dipole antenna, comprising:
a first rod antenna portion;
a first helical antenna portion, connected to the first rod antenna portion, and having a first helical pitch;
a second rod antenna portion, connected to the first helical antenna portion;
a second helical antenna portion, connected to the second rod antenna portion, and having a second helical pitch; and
an impedance matching portion, connected to the second helical antenna portion, for matching a line impedance of the dipole antenna.

2. The omni-directional high gain dipole antenna as claimed in claim 1, wherein lengths of the first rod antenna portion, the first helical antenna portion, the second rod antenna portion, and the second helical antenna portion are ½ wavelength (λ) of a carrier frequency.

3. The omni-directional high gain dipole antenna as claimed in claim 1, wherein the second helical antenna portion is fixed to the impedance matching portion by welding.

4. The omni-directional high gain dipole antenna as claimed in claim 1, wherein the first helical pitch is smaller than the second helical pitch.

5. The omni-directional high gain dipole antenna as claimed in claim 1, wherein the first helical pitch is greater than the second helical pitch.

6. The omni-directional high gain dipole antenna as claimed in claim 1, wherein the first rod antenna portion, the first helical antenna portion, the second rod antenna portion, and the second helical antenna portion are connected to each other by welding.

7. The omni-directional high gain dipole antenna as claimed in claim 1, wherein the first rod antenna portion, the first helical antenna portion, the second rod antenna portion, and the second helical antenna portion are integrally formed.

8. The omni-directional high gain dipole antenna as claimed in claim 1, wherein the impedance matching portion further has a signal feed-in point connected to a signal cable, for transmitting a wireless signal.
